(19) United States
(12) Patent Application Publication
(10) Pub. No.: US 2009/0090761 A1
(43) Pub. Date: Apr. 9, 2009

(54) AIR NAIL GUN

(76) Inventor: Jacob Chen, Tai-Li City (TW)

Correspondence Address: PAI PATENT & TRADEMARK LAW FIRM, 1001 FOURTH AVENUE, SUITE 3200, SEATTLE, WA, 98154, US

(21) Appl. No.: 11/868,482

(22) Filed: Oct. 6, 2007

(51) Int. Cl. B25C 1/04

(52) U.S. Cl. 227/130

(57) ABSTRACT

In an air nail gun, a stop ring is movably mounted around a movable seal member, which controls the supply of a compressed air into an air chamber to force a piston and a firing pin and to further drive a nail out of the air nail gun, having an upper inside wall disposed in contact with the movable seal member in an airtight status, a lower inside wall, and an inside annular flange disposed between the upper inside wall and the lower inside wall and protruding toward the movable seal member such that when the movable seal member is returned upon each nail firing action the stop ring is kept in position to prohibit the compressed air from moving through the movable seal member, and the movable seal member carries the stop ring toward a top block when an outside annular flange of the movable seal member touches the inside annular flange of the stop ring.

### BACKGROUND OF THE INVENTION

1. Field of the Invention

The present invention relates to an air nail gun and more particularly, to an air nail gun that uses the power source of compressed air to drive nails into the workpiece.

2. Description of the Related Art

Referring to FIGS. 1˜3, a regular air nail gun comprises a housing 1, an air chamber 10 defined within the housing 1, a piston 2 slidably mounted in the air chamber 10, a firing pin 3 connected to the piston 2 for driving a nail (not shown) out of the air nail gun, a top block 4 fixedly mounted inside the housing 1 at the top and adapted to stop the piston 2, and a movable seal member 5 movably set in between the piston 2 and the top block 4.

Referring to FIG. 1, when at the initial status (not firing), the movable seal member 5 provides an opening 50 at its center for allowing the piston 2 to pass and to contact the top block 4. At this time, the movable seal member 5 is closely stopped against one end of the air chamber 10 to stop compressed air from entering the air chamber 10. When the trigger 6 of the air nail gun is operated, compressed air is released to force the movable seal member 5 toward the top block 4, as shown in FIG. 2, and a gap is left between the movable seal member 5 and the air chamber 10 for allowing compressed air to enter the air chamber 10 and to further push the piston 2 toward the firing direction. At this time, the piston 2 is disengaged from the top block 4, and compressed air goes through the opening 50 into the gap in between the top block 4 and the movable seal member 5. Because the movable seal member 5 does not reach the final position at this time, compressed air will leak out through the top block 4 (see the arrowhead sign). When the movable seal member 5 reaches the final position as shown in FIG. 3, the gap between the movable seal member 5 and the top block 4 is disappeared, and compressed air is prohibited from leaking out. Therefore, a small amount of compressed air leaks through the gap between the top block 4 and the movable seal member 5 at the moment a nail is fired, and the pressure of compressed air is slightly reduced at this time. Therefore, the air compressor must be frequently started to supply compressed air, resulting in high power consumption.

### SUMMARY OF THE INVENTION

The present invention has been accomplished under the circumstances in view. It is therefore the main object of the present invention to provide an air nail gun, which prohibits air leakage at the moment when a nail is fired.

To achieve this and other objects of the present invention, the air nail gun comprises a housing, an air chamber defined within the housing, a piston slidably mounted in the air chamber, a firing pin connected to the piston outside the air chamber for driving a nail out of the air nail gun, a top block fixedly mounted at a top side inside the housing and adapted to stop the piston, and a movable seal member movably set in between the piston and the top block, the movable seal member being moved to control supply of compressed air into the air chamber to move the piston and the firing pin and to further drive a nail out of the air nail gun. The invention further comprises a stop ring mounted around the movable seal member and movable relative to the movable seal member. The stop ring has an upper inside wall disposed in contact with the movable seal member in an airtight status, a lower inside wall, and an inside annular flange disposed between the upper inside wall and the lower inside wall and protruding toward the movable seal member. The lower inside wall has a cross-sectional area greater than the cross-sectional area of the upper inside wall. Further, the movable seal member has an outside annular flange for contacting the inside annular flange of the stop ring. When the movable seal member is forced by a compressed air toward the top block, the stop ring is kept in position to prohibit the compressed air from moving through the movable seal member, and the movable seal member carries the stop ring toward the top block when the outside annular flange of the movable seal member touches the inside annular flange of the stop ring. Therefore, the compressed air is prohibited from moving through the gap between the movable seat and the top block.

### BRIEF DESCRIPTION OF THE DRAWINGS

FIG. 1 is a schematic drawing of a prior art air nail gun when not operated.

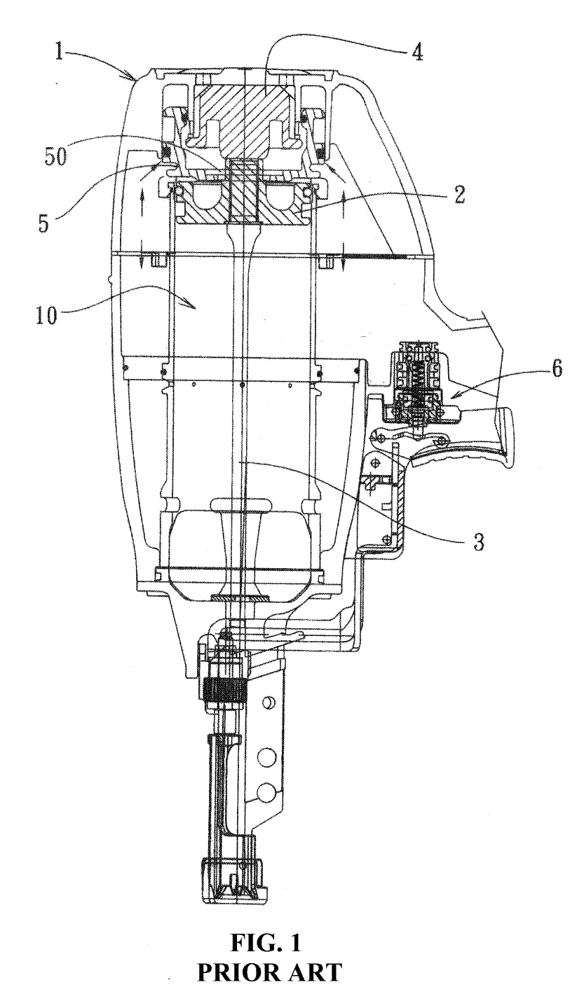

FIG. 2 is a schematic drawing of the prior art air gun showing the status of the internal parts during a firing action.

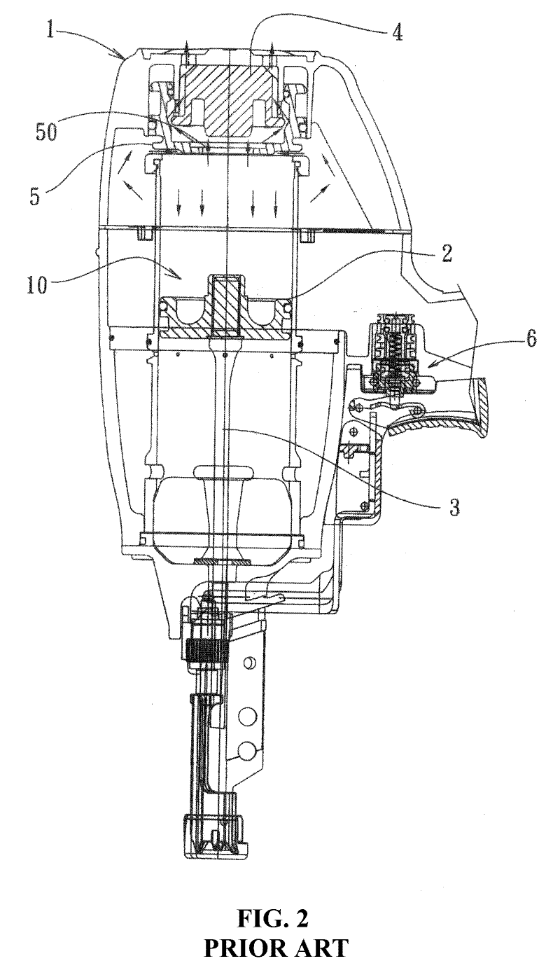

FIG. 3 is a schematic drawing of the prior art air gun showing the status of the internal parts after a firing action.

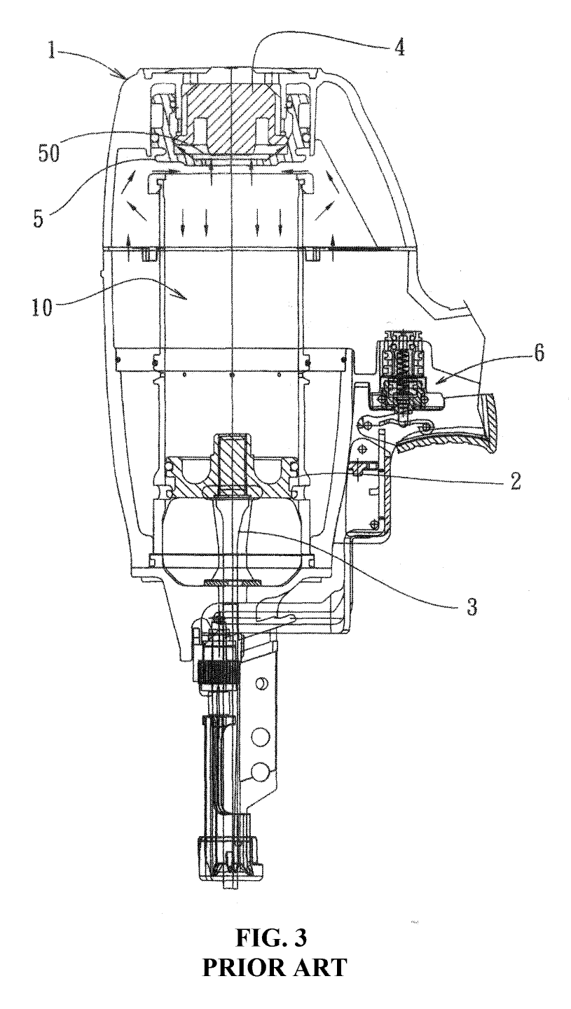

FIG. 4 is a schematic drawing of an air gun according to the present invention, showing the status of the internal parts when not operated.

FIG. 5 is a schematic drawing of the present invention, showing the status of the internal parts during a firing action (I).

FIG. 6 is a schematic drawing of the present invention, showing the status of the internal parts during a firing action (II).

FIG. 7 is a schematic drawing of the present invention, showing the status of the internal parts of the air nail gun after a firing action.

### DETAILED DESCRIPTION OF THE PREFERRED EMBODIMENT

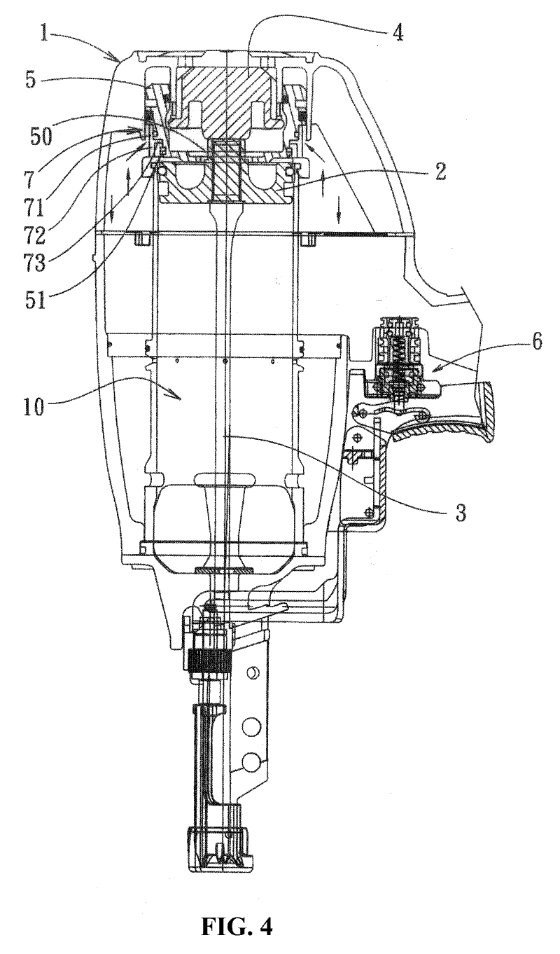

Referring to FIGS. 4˜7, an air nail gun constructed in accordance with the present invention is shown comprising a housing 1 defining therein an air chamber 10, a piston 2 slidably mounted in the air chamber 10, a firing pin 3 connected to the piston 2 for driving a nail (not shown) out of the air nail gun, a top block 4 fixedly mounted inside the housing 1 at the top and adapted to stop the piston 2, and a movable seal member 5 movably set in between the piston 2 and the top block 4. Subject to change of position of the movable seal member 5, compressed air is directed toward the piston 2, forcing the firing pin 3 to drive a nail out of the air nail gun. Because the related operating principle is same as conventional air nail guns, no further detailed description in this regard is necessary.

The main features of the present invention are outlined hereinafter. A stop ring 7 is mounted around the movable seal member 5 and movable relative to the movable seal member 5. The stop ring 7 has an upper inside wall 71, a lower inside wall 72, and an inside annular flange 73 disposed between the upper inside wall 71 and the lower inside wall 72 and protruding toward the movable seal member 5. The cross-sectional area of the lower inside wall 72 is greater than the cross-sectional area of the upper inside wall 71.

The movable seal member 5 has an outside annular flange 51 for contacting the inside annular flange 73. The upper inside wall 71 of the stop ring 7 is kept in contact with the movable seal member 5 in an airtight status.

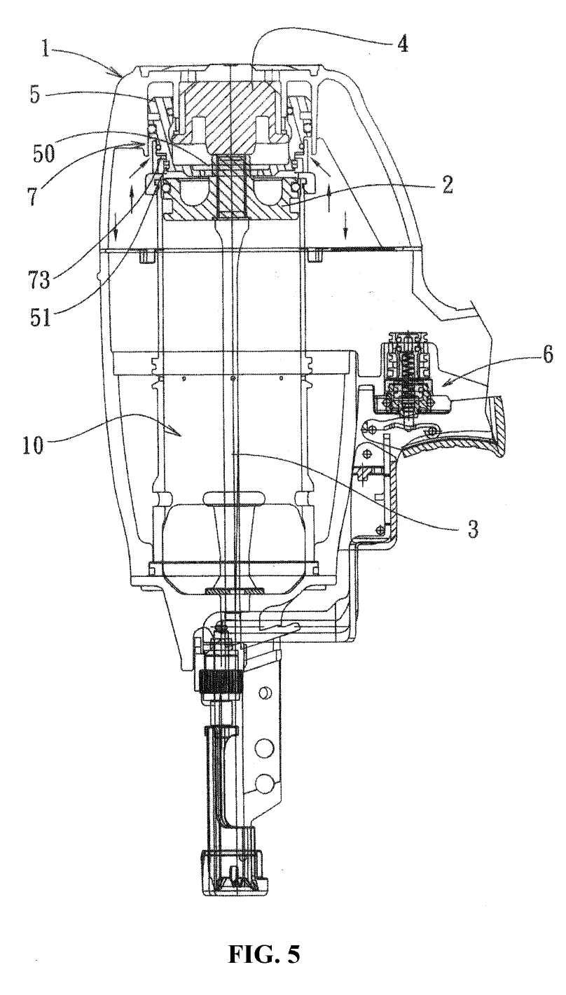

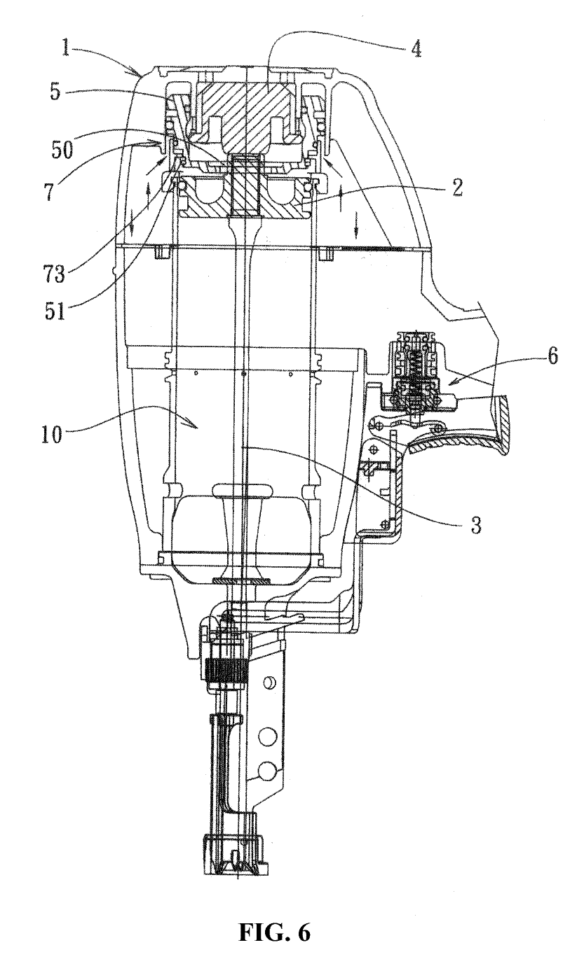

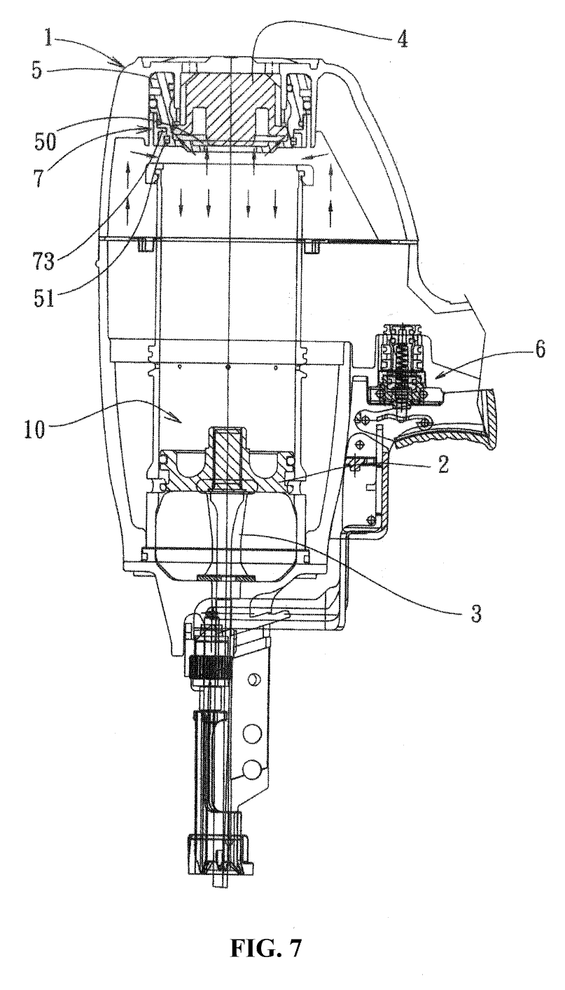

Referring to FIG. 4 again, when the air nail gun is not operated, the stop ring 7 is stopped against one end of the air chamber 10, keeping the air chamber 10 in an airtight status and prohibited compressed air from entering the air chamber 10. When the trigger 6 of the air nail gun is operated as shown in FIG. 5, compressed air pushes the movable seal member 5 toward the top block 4. Because the stop ring 7 is movably mounted on the movable seal member 5, moving the movable seal member 5 toward the top block 4 does not cause movement of the stop ring 7 with the movable seal member 5, i.e. the stop ring 7 is kept in position to prohibit compressed air from moving through the movable seal member 5, and therefore the effect of the stop ring 7 prohibits compressed air from entering the air chamber 10, as shown in FIG. 6. When the outside annular flange 51 of the movable seal member 5 touches the inside annular flange 73, the movable seal member 5 carries the stop ring 7 toward the top block 4, as shown in FIG. 7. During movement of the stop ring 7 with the movable seal member 5, the stop ring 7 will move upwards for a distance for allow a big amount of air to go into the inside of the air chamber 10, due to the effect that the cross-sectional area of the lower inside wall 72 is greater than the cross-sectional area of the upper inside wall 71, forcing the piston 2 toward the firing direction and prohibiting leakage of compressed air through the top block 4 upon firing of a nail.

As stated above, the design of the stop ring 7 prohibits compressed air from moving over the movable seal member 5 to the outside via the top block 4 during movement of the movable seal member 5 toward the top block 4. Therefore, the invention effectively prohibits air leakage when a nail is fired, thereby reducing the number of starting action of the air compressor and saving much power consumption.

Although particular embodiments of the invention have been described in detail for purposes of illustration, various modifications and enhancements may be made without departing from the spirit and scope of the invention.

What the invention claimed is:

1. An air nail gun comprising a housing, an air chamber defined within said housing, a piston slidably mounted in said air chamber, a firing pin connected to said piston outside said air chamber for driving a nail out of the air nail gun, a top block fixedly mounted at a top side inside said housing and adapted to stop said piston, and a movable seal member movably set in between said piston and said top block, said movable seal member being moved to control supply of compressed air into said air chamber to move said piston and said firing pin and to further drive a nail out of the air nail gun;
wherein a stop ring is mounted around said movable seal member and movable relative to said movable seal member, said stop ring having an upper inside wall disposed in contact with said movable seal member in an airtight status, a lower inside wall, and an inside annular flange disposed between said upper inside wall and said lower inside wall and protruding toward said movable seal member, said lower inside wall having a cross-sectional area greater than the cross-sectional area of said upper inside wall; said movable seal member has an outside annular flange for contacting said inside annular flange of said stop ring such that when said movable seal member is forced by a compressed air toward said top block, said stop ring is kept in position to prohibit the compressed air from moving through said movable seal member, and said movable seal member carries said stop ring toward said top block when the outside annular flange of said movable seal member touches the inside annular flange of said stop ring.
